(19) United States
(12) Patent Application Publication
(10) Pub. No.: US 2009/0034902 A1
(43) Pub. Date: Feb. 5, 2009

(54) Method for Increasing Signal Intensity in An Optical Waveguide Sensor

(75) Inventor: Alexandre Izmailov, Toronto (CA)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Healthcare Diagnostics Inc., Tarrytown, NY (US)

(21) Appl. No.: 12/160,112

(22) PCT Filed: Jan. 5, 2007
(86) PCT No.: PCT/US07/60163

§ 371 Date: Jul. 7, 2008

Related U.S. Application Data
(60) Provisional application No. 60/757,073, filed on Jan. 6, 2006.

(51) Int. Cl. G02B 6/00

(52) U.S. Cl. 385/12

(57) ABSTRACT

A sensor platform for use in sample analysis comprises a substrate (30) of refractive index m and a thin, optically transparent layer (32) of refractive index (n₂) on the substrate, where n₂ is greater than n₁. The platform includes one of more sensing areas each for one or more capture elements. The platform also includes an immersion fluid with a refractive index n₃ greater than an aqueous buffer but less than n₂ to enhance the fluorescent signal of an affinity reaction. Also disclosed are an apparatus incorporating the platform and a method of using the platform.

### TECHNICAL FIELD OF THE INVENTION

This invention relates generally to the field of optical waveguide sensors and methods of detecting analytes using optical wave guide sensors.

### BACKGROUND OF THE INVENTION

A variety of optical techniques are used to analyze biological samples based on measured changes in absorption, fluorescence, scatter, and refractive index. For example, optical wave guide sensors utilize optical waveguide element that respond to a change in environment, such as binding of a target analyte to its surface. The optical waveguiding element conveys light from one point to another through an optically transparent elongated structure by modal transmission, total internal reflection, or total reflectorization, while substantially confining the radiation to a region within and adjacent to its surfaces. An optical waveguide sensor typically includes an optically transparent substrate, an optically transparent film bound to a surface of the substrate, and an analyte specific capture layer bound to the transparent layer, which is adapted to specifically bind a desired target analyte, resulting in a change in optical properties that can be detected, for example, as a change in the evanescent field.

Evanescent waveguide sensors may be used to detect fluorescence induced by the evanescent field, changes in refractive index which occur when molecules of a sample bind to capture molecules, and surface plasmon resonance. Use of an evanescent wave to induce excitation of a bound analyte has a number of advantages: (1) the excitation light path is separated from the sensing region; (2) the light probes only a surface layer to which the analyte is bound, and is not modified by the bulk of the sample; and (3) the test volume may be limited to a few microliters. Notwithstanding these advantages, the evanescent wave of a waveguide sensor decreases exponentially with distance away from the surface of the waveguide layer, limiting sensitivity.

Accordingly, there is a need in the art to improve sensitivity of optical waveguide sensors.

### SUMMARY OF THE INVENTION

The present invention relates to novel optical waveguide sensor devices and methods of using optical waveguide sensor devices having improved sensitivity. In particular, the methods and devices of the invention increase the depth of penetration of the evanescent wave outside of the waveguide and into the optical sensing area, leading to significantly improved light intensity and sensitivity, and allow samples to be detected and/or analyzed in a more sensitive, reliable, and quantitative manner.

In a first aspect, the present invention relates to optical waveguide sensors for detecting the presence or absence of an analyte in a sample, comprising an optically transparent substrate having a refractive index n₁, an optically transparent film bound to a surface of the substrate, wherein the transparent film has a refractive index n₂, and wherein n₂ is greater than n₁, an analyte specific capture layer bound to the transparent film, wherein the capture layer is adapted to bind an analyte, if present, in a sample placed in contact with the capture layer, an optical immersion layer overlaying the capture layer and analyte, if present, wherein the optical immersion layer has a refractive index n₃, and wherein n₃ is less than n₂ and greater than the refractive index of an aqueous buffer solution.

In some embodiments, n₃ is greater than 1.33 and less than n₂. In some embodiments, n₃ is from about 1.35 to about 1.75. In some embodiments, n₃ is from about 1.36 to about 1.75. In some embodiments, n₃ is from about 1.37 to about 1.75. In some embodiments, n₃ is from about 1.38 to about 1.75. In some embodiments, n₃ is from about 1.39 to about 1.75. In some embodiments, n₃ is from about 1.4 to about 1.73. In some embodiments, n₃ is from about 1.45 to about 1.7. In some embodiments, n₃ is from about 1.5, to about 1.68. In some embodiments, n₃ is from about 1.55 to about 1.65. In some embodiments, n₃ is about 1.6. In some embodiments, n₃ is greater than about 1.35 and less than n₂. In some embodiments, n₃ is greater than about 1.4 and less than n₂. In some embodiments, n₃ is greater than about 1.45 and less than n₂. In some embodiments, n₃ is greater than about 1.5 and less than n₂. In some embodiments, n₃ is greater than about 1.55 and less than n₂.

The optical waveguide sensor may also include a sample suspected of containing an analyte in contact with the analyte specific capture layer. The optical waveguide sensor may also comprise an analyte, wherein the analyte is bound to the analyte specific capture layer.

In some embodiments, the optical waveguide sensor may also comprise a diffraction grating oriented between the optically transparent substrate and the optically transparent film. In some embodiments, the optical waveguide sensor may also comprise a reflector oriented opposite the diffraction grating. In some embodiments, the reflector may be a retro reflector. In some embodiments, the reflector may be a Bragg reflector.

The analyte specific capture layer may comprise one or more capture elements selected from one or more of a nucleotide, an oligonucleotide, DNA, RNA, PNA, an antibody, an antigen, a protein, an antibiotic, a drug, an enzyme, a ligand, a peptide, a polymer, a molecular probe, and a receptor.

The optical waveguide sensor may also comprise a detectable label capable of indicating the presence or absence of an analyte.

The optical waveguide sensor may also comprise sensing areas arranged in an array.

In another aspect, the present invention relates to optical waveguide devices for detecting the presence or absence of an analyte in a sample, comprising: (a) an optical waveguide sensor, comprising: an optically transparent substrate having a refractive index n₁, an optically transparent film bound to a surface of the substrate, wherein the transparent film has a refractive index n₂, and wherein n₂ is greater than n₁, an analyte specific capture layer bound to the transparent film, an optical immersion layer overlaying the capture layer, wherein the optical immersion layer has a refractive index n₃, and wherein n₃ less than n₂ and greater than the refractive index of an aqueous buffer solution; (b) a coupling device for transmitting excitation light in the transparent film; (c) a light source configured to emit light to the thin film; (d) a light detector configured to receive light coming from the sensor. The waveguide sensor may be modified as previously summarized.

In still another aspect, a process for using an optical waveguide sensor for detecting the presence or absence of an analyte in a sample is described, comprising: (a) providing an optical waveguide sensor comprising: an optically transparent substrate having a refractive index n₁, an optically transparent film bound to a surface of the substrate, wherein the transparent film has a refractive index n₂, and wherein n₂ is greater than n₁, an analyte specific capture layer bound to the transparent film; (b) contacting the analyte specific capture layer with a sample suspected of containing an analyte; (c) overlaying the analyte specific capture layer with an optical immersion fluid, wherein the optical immersion fluid has a refractive index n₃ less than n₂ and n₃ greater than an aqueous buffer solution. The waveguide sensor may be modified as previously summarized.

In some embodiments, the sample is in a solution, and the optical immersion fluid replaces the buffer solution. In other examples, the solution is mixed with the immersion fluid when the analyte specific capture layer is overlaid with the optical immersion fluid resulting in a mixed fluid with an index of refraction greater than 1.33. In additional examples, the immersion fluid and the solution are immiscible and form separate fluid layers. The waveguide sensor used in the process may be modified as previously summarized.

In yet another aspect, the present invention relates to kits for detecting the presence or absence of an analyte in a sample is provided, comprising: (a) a waveguide sensor comprising: an optically transparent substrate having a refractive index n₁, an optically transparent film bound to a surface of the substrate, wherein the transparent film has a refractive index n₂, and wherein n₂ is greater than n₁, an analyte specific capture layer bound to the transparent film; (b) an optical immersion fluid, wherein the immersion fluid has a refractive index n₃ and n₃ is less than n₂ and greater than an aqueous buffer solution. The waveguide sensor used in the process may be modified as previously summarized.

In some embodiments, the kit may also include materials for making a buffer solution such as organic or inorganic salts, and solvent such as water. In some embodiments, the kit may also include a buffer solution.

### BRIEF DESCRIPTION OF THE DRAWINGS

FIG. 1 is a schematic illustration of an apparatus for analyzing the optical parameters and the evanescent resonance condition of a waveguide platform.

FIG. 2 is a schematic illustration of a sensor platform.

FIG. 3 is a schematic view showing the evanescent field profile in relation to the platform.

FIG. 4 shows schematically the layout used to measure fluorescence with a sensor platform.

FIGS. 5a and 5b are schematic views showing a chip cartridge.

FIG. 6 is a side schematic view of a planar waveguide with a Bragg reflector.

FIG. 7 is a top schematic view of a planar waveguide with a retro reflector.

FIG. 8 is graph displaying relative fluorescence intensity of AF750 spots as a function of refractive index and immersion fluids.

FIG. 9 is a graph displaying average relative fluorescence intensity as a function of exposure time for AF750 spotted chips suspended in buffer or immersed in a liquid with a refractive index of 1.6.

### DETAILED DESCRIPTION OF THE INVENTION

### Definitions

While the terminology used in this application is standard within the art, the following definitions of certain terms are provided to assure clarity.

Units, prefixes, and symbols may be denoted in their SI accepted form. Numeric ranges recited herein are inclusive of the numbers defining the range and include and are supportive of each integer within the defined range. Unless otherwise noted, the terms “a” or “an” are to be construed as meaning “at least one of.” The section headings used herein are for organizational purposes only and are not to be construed as limiting the subject matter described. All documents, or portions of documents, cited in this application, including but not limited to patents, patent applications, articles, books, and treatises, are hereby expressly incorporated by reference in their entirety for any purpose.

As used herein, the term “affinity reaction” means a reaction that results in the association of two or more molecules not collectively associated together before the reaction.

As used herein, the term “analyte solution” means a solution containing molecules to be analyzed (an analyte or analytes), such as a buffer solution or other liquid.

As used herein, the term “analyte specific” as in reference to a capture element or capture layer means the capture element or layer is capable of specifically binding an analyte.

As used herein, the term “bound” means any form of chemical linkage or association such as from hydrogen bonding, covalent bonds, electrostatic interactions, hydrophobic interactions, and the like.

As used herein, the term “capture elements” means one or more molecules capable of specifically binding to and capturing a target analyte. In some embodiments, the capture element includes an adhesion layer.

As used herein, the term “capture layer” means a two-dimensional surface including one or more capture elements capable of binding to a specific analyte. The capture layer can be bound to the transparent film directly or indirectly such that a link or connection exists between the analyte and the transparent film.

As used herein, the term “capture molecule” means an individual molecule capable of specifically binding to and capturing a target analyte.

As used herein, the term “film” means an optically transparent thin layer, coating one or more surfaces of a substrate (or portions thereof), and having an index of refraction greater than both the substrate it coats and an analyte solution.

As used herein, the term “immersion fluid” means a fluid with a refractive index greater than an aqueous solution, such as a buffer solution. The immersion fluid has a refractive index greater than 1.33.

As used herein, the term “overlaying” or “overlaid” means to cover a surface, including the entire surface or some portion thereof. The terms also mean to cover a surface (or some portion thereof) where that surface is partially or fully covered by an intermediate layer. Overlaying can be construed to mean replacing, displacing, overlapping, and mixing with another surface to cover a surface.

As used herein, the term “platform” means a whole transducer/chip containing one or a plurality of sensing areas.

As used herein, the term “sensing area” means an area capable of receiving an evanescent field by a resonance effect and containing one or more capture elements.

As used herein, the term “substrate” means an optically transparent base or foundation to which a waveguide film is bound.

The practice of the present invention will employ, unless otherwise indicated, conventional techniques and devices used in connection with optical waveguide detection and analysis, molecular biology, microbiology, recombinant DNA techniques, and oligonucleotide synthesis, which are within the skill of the art. Such techniques are explained fully in the literature.

The present invention is generally directed to methods, devices, and kits for detecting fluorescence in excited samples. Fluorescence detection may be achieved using a sensor platform. It will be appreciated that the use of such a platform is not necessarily restricted to the particular applications described. The platform also enables detection of the absence or presence of an analyte. Other techniques may be used in conjunction with the components described herein. The following description provides a general explanation of the ways in which the platform can be used to determine fluorescence of samples.

The structure of an optical waveguide sensor may include a planar substrate having formed thereon a thin film layer for guiding a light wave. Devices incorporating the planar waveguide sensor may include a device for coupling excitation light into the wave-guiding layer. This device can be in the form of a diffraction grating or prism. The light of excitation that is coupled into the waveguide layer is partially confined in this layer, but also produces so-called evanescent electromagnetic fields, which extend a small distance outside the waveguide. This evanescent excitation or interaction is limited to a region very close to the surface of the waveguide, typically 100-150 nanometers for visible light. Exponential decay of the intensity of evanescent field implies that the intensity of the light at the greater distance from the waveguide layer is not sufficient for noticeable excitation of molecules. This explains why low background levels are observed with such devices. Because the bulk of a sample does not interfere with the light either on its path to and from the sensing region or at the sensing layer, there is no need to separate out potential optical obstructions, for example, the cells in a blood sample, that may interfere with the interaction of the light with the target analyte. The evanescent field can therefore selectively interact with molecules attached to the surface of the sensor.

A sensing area typically includes immobilized capture molecules to which the target analyte binds. A sample containing the target analyte may be brought into contact with the sensing area in the presence of added labeled molecules with similar affinity (competition). Alternatively, analyte molecules may bind to immobilized capture molecules and fluorescence labels are introduced by reaction of a further labeled species with a captured analyte molecule. Light projected into the waveguide layer leads to evanescent excitation of the fluorophores that then allow detection and/or quantification of the analyte. The emitted fluorescence is detected and the intensity of the fluorescence indicates that an interaction has occurred between affinity partners present in the analyte and the immobilized capture molecules.

Abnormal reflection is a phenomenon that has been described by S. S. Wang and R. Magnusson (“Theory and applications of guided mode resonance filters,” Applied Optics, Vol. 32, No 14, 10 May 1993, p. 2606-2613) and by O. Parriaux et al. (“Coupling gratings as waveguide functional elements” Pure & Applied Optics 5, 1996, p. 453-469). As explained in these papers, resonance phenomena can occur in planar dielectric layer diffraction gratings where almost 100% switching of optical energy between reflected and transmitted waves occurs when the grooves of a diffraction grating have sufficient depth, and the radiation incident on the corrugated structure is at a particular angle. The evanescent field propagated by transmitted waves is used to excite an analyte under investigation. It should be noted that the 100% switching referred to above occurs with parallel beam and linearly polarized coherent light, and the effect of an enhanced evanescent field can also be achieved with non-polarized light of a non-parallel focused laser beam. At resonance conditions, the individual beams interfere in such a way that the transmitted beam is cancelled out (destructive interference), and the reflected beam interferes constructively giving rise to abnormally high reflection.

The platform or sensor can be considered as a system with enhanced power density that is achieved by confinement of the electromagnetic field of the excitation beam in a thin layer and enhanced penetration of the evanescent field into a sensing area.

Substrate

The substrate of the planar waveguide sensor can be constructed in a manner and using materials well known in the art. Generally, the substrate will be optically transparent, capable of transmitting light from a light source to the film layer, and sufficiently rigid to provide physical support to the film layer. The substrate preferably allows deposition of a layer with a greater refractive index on its surface with reasonable adhesion. It may be advantageous to use low fluorescent materials for the substrate in order to reduce background distortions and interference. Surface roughness may be minimized to reduce light losses due to light scattering at the substrate-film interface and an associated potential increased in background fluorescence.

The substrate of the waveguide may also be formed from a variety of materials such as those mentioned in T. Kaino, “Polymer Optical Fibers,” in Polymers for Lightwave and Integrated Optics, L. Hornak, ed., Marcel-Dekkar Inc., New York, 1992. For example, inorganic materials such as glass, SiO₂, quartz, or similar substances may be used. Alternatively, the substrate can be formed from organic materials such as polymers such as polycarbonate, poly(methyl)methacrylate, polyimide, polystyrene, polyethylene, polyethylene terephthalate or polyurethane. These organic materials may also be used for point-of-care and personalized medical applications since glass can be undesirable in such environments. Also, plastic substrates can be structured (embossed) much more easily than glass.

Film Layer

The film layer of the planar waveguide sensor is also constructed in a manner and using materials well known in the art. Generally, the film layer will be optically transparent, capable of receiving light from the substrate and transmitting the light to sensing areas on the surface of the film. The film layer preferably has a refractive index higher than the refractive indices of both the substrate and the analyte solution. The film layer may have a chemical composition sufficient to permit direct or indirect attachment of the captures elements. In one aspect, the chemical composition permits indirect attachment of the capture elements, by means of an intermediate adhesion promoting layer (described below). In another aspect, the chemical composition of the film layer permits direct binding of the capture elements, by means of chemical or molecular binding forces between the film and the capture elements.

The optically transparent layer (or film) may be formed from inorganic material. Alternatively, it may be formed from organic material. In one example, the optically transparent layer is a metal oxide such as Ta₂O₅, TiO₂, Nb₂O₅, ZrO₂, or HfO₂.

Alternatively, the optically transparent material may be a polyamide, polyimide, polypropylene, PS, PMMA, polyacryl acids, polyacryl ethers, polythioether, poly(phenylenesulfide), and derivatives thereof (see for example S. S. Hardecker et al., J. of Polymer Science B: Polymer Physics, Vol. 31 1591-63, 1993).

The substrate and optically transparent layer may be any shape, such as a square, rectangle, or disc-shaped.

Sensing Area

The film layer of the planar waveguide sensor will generally have distinct sensing areas that define regions within which the analyte is bound and can be detected. While it is possible to use a planar waveguide sensor to analyze a single sample containing an analyte, a particular advantage of a planar waveguide sensor is that multiple samples may be analyzed on a single sensor platform. Thus, in another aspect, the planar waveguide sensor has a plurality of sensing areas, each area defined for receiving a single sample. The surface of a single sensing area may be optimized for one particular excitation wavelength. By appropriate means, e.g. superposition of several periodic structures that are parallel or perpendicular one with another, periodic surface reliefs may be obtained that are suitable for multiple wavelength use of the platform (“multicolor” applications). Alternatively, individual sensing areas on one platform may be optimized for different wavelengths and/or polarization orientations.

The surface of the optically transparent layer may include one or a plurality of sensing areas in which each area may carry one or more capture elements. Each capture element may contain individual and/or mixtures of capture molecules that are capable of affinity reactions. The shape of an individual capture element may be rectangular, circular, ellipsoidal, or any other shape. The area of an individual capture element can be varied such as between 1 μm² and 10 mm², e.g. between 20 μm² and 1 mm² and preferably between 100 μm² and 1 mm². The capture elements may be arranged in arrays, such as a two-dimensional array. The center-to-center (ctc) distance of the capture elements may also vary such as between 1 μm and 1 mm, e.g. 5 μm to 1 mm and 10 μm to 1 mm.

The number of capture elements per sensing area may also be varied such as between 1 and 1,000,000, or 1 and 100,000. In another aspect, the number of capture elements to be immobilized on the platform corresponds to a number of genes, DNA sequences, DNA motifs, DNA micro satellites, single nucleotide polymorphisms (SNPs), proteins or cell fragments constituting a genome of a species or organism of interest, or a selection or combination thereof. In a further aspect, the platform contains the genomes of two or more species, e.g. mouse and rat.

Adhesion Promoting Layer

Optionally, the platform may also include an adhesion promoting layer on the surface of the optically transparent layer in order to enable immobilization of capture molecules. The adhesion promoting layer may be made of a polymer, for example KBD, Lupamin and such, and may be deposited on the surface by any known method of surface film formation such as spin coating. This film is preferably compatible with the analyte and analyte solution and without significantly quenching fluorescence. Homogeneity of this film in terms of thickness and reproducibility of its chemical properties across the surface provides for more reproducible measurements.

Light Source

Electromagnetic irradiation is provided by means of a light source capable of projecting a light beam. The light beam generator may also direct the beam so that it is incident upon the platform at an angle that causes wave-guiding mode of light propagation to occur in the platform, thereby creating an enhanced evanescent field in the sensing area of the platform. The range of angles suitable for creating waveguide conditions is limited by the angle of total reflection for incident light on the platform. It is defined by film thickness and refractive index of the film as well as by the refractive indices of the substrate and analyte solution. The light generating means may comprise a laser for emitting a coherent laser beam. Other suitable light sources include discharge lamps or low-pressure lamps, e.g. Hg or Xe, where the emitted spectral lines have sufficient coherence length, and light-emitting diodes (LED). The apparatus may also include optical elements for directing the laser beam so that it is incident on the platform at an angle θ, and elements for rotating the plane of polarization of the coherent beam, e.g. adapted to transmit linearly-polarized light.

Examples of lasers that may be used are gas lasers, solid state lasers, dye lasers, semiconductor lasers. If necessary, the emission wavelength can be doubled by means of non-linear optical elements. Suitable lasers include diode lasers or frequency doubled diode lasers of semiconductor material that have small dimensions and low power consumption.

Samples

Typically, the samples are introduced to sensing areas in a buffered delivery solution containing the target analyte of interest. The samples may be delivered either undiluted or with added solvents. Suitable solvents include water, aqueous buffer solutions, protein solutions, natural or artificial oligomer or polymer solutions, and organic solvents. Suitable organic solvents include alcohols, ketones, esters, aliphatic hydrocarbons, aldehydes, acetonitrile or nitrites.

Solubilizers or additives may be included, and may be organic or inorganic compounds or biochemical reagents such as diethylpyrocarbonate, phenol, formamide, SSC (sodium citrate/sodium chloride), DSD (sodiumdodecylsuflate), buffer reagents, enzymes, reverse transcriptase, RNAase, organic or inorganic polymers. Buffer reagents used to stabilize analytes can include a wide variety of materials.

The sample may also include constituents that are not soluble in the solvents used, such as pigment particles, dispersants and natural and synthetic oligomers or polymers.

Dyes

The fluorescent dyes used as markers may be chemically or physically, for instance electrostatically, bonded to one or multiple affinity binding partners (or derivatives thereof) present in the analyte solution and/or attached to the platform. In case of naturally occurring oligomers or polymers such as DNA, RNA, saccharides, proteins, or peptides, as well as synthetic oligomers or polymers, involved in the affinity reaction, intercalating dyes are also suitable. Fluorophores may be attached to affinity partners present in the analyte solution via biological interaction such as biotin/avidin binding or metal complex formation such as HIS-tag coupling.

One or multiple fluorescent markers may be attached to affinity partners present in the analyte solution, to capture elements immobilized on the platform, or both to affinity partners present in the analyte solution and capture elements immobilized on the platform, in order to quantitatively determine the presence of one or multiple affinity binding partners. The spectroscopic properties of the fluorescent markers may be chosen to match the conditions for Förster Energy Transfer (FET) or Photoinduced Electron Transfer (PET). Distance and concentration dependent fluorescence of acceptors and donors may then be used for the quantification of analyte molecules.

Quantification of affinity partners may be used on intermolecular and/or intramolecular interaction between such donors and acceptors bound to molecules involved in affinity reactions. Intramolecular assemblies of fluorescence donors and acceptors covalently linked to affinity binding partners, Molecular Beacons (S. Tyagi et al., Nature Biotechnology 1996, 14, 303-308) that change the distance between donor and acceptor upon affinity reaction, may also be used as capture molecules or additives for the analyte solution. In addition, pH and potentially sensitive fluorophores or fluorophores sensitive to enzyme activity may be used, such as enzyme-mediated formation of fluorescing derivatives.

Transfluorospheres or derivatives thereof may be used for fluorescence labeling. Chemi- or electro-luminescent molecules may be used as markers as well.

Fluorescent compounds having fluorescence in the range of from 400 nm to 1200 nm which are functionalized or modified in order to be attached to one or more of the affinity partners, such as derivatives of polyphenyl and heteroaromatic compounds stilbenes, coumarines, xanthene dyes, methine dyes, oxazine dyes, rhodamines, fluoresceines, coumarines, stilbenes, pyrenes, perylenes, cyanines, oxacyanines, phthalocyanines, porphyrines, naphthalopcyanines, azobenzene derivatives, distyryl biphenyls, transition metal complexes e.g. polypyridyl/ruthenium complexes, tris(2,2′-bipyridyl)ruthenium chloride, tris(1,10-phenanthroline)ruthenium chloride, tris(4,7-diphenyl-1,10-phenanthroline) ruthenium chloride and polypyridyl/phenazine/ruthenium complexes, such as octaethyl-platinum-porphyrin, Europium and Terbium complexes may be used as fluorescent markers.

Suitable for analysis of blood or serum are dyes having absorption and emission wavelengths in the range from 400 nm to 1000 nm. Furthermore fluorophores suitable for two and three photon excitation can be used.

Dyes that are suitable for fluorescent detection may contain functional groups for covalent bonding, e.g. fluorescein derivatives such as fluorescein isothiocyanate. Also suitable are the functional fluorescent dyes commercially available from Amersham Life Science, Inc. Texas and Molecular Probes Inc.

Other suitable dyes include dyes modified with deoxynucleotide triphosphate (dNTP) which can be enzymatically incorporated into RNA or DNA strands. Further suitable dyes include Quantum Dot Particles or Beads (Quantum Dot Cooperation, Palo Alto, Calif.) or derivatives thereof or derivatives of transition metal complexes that may be excited at one and the same defined wavelength, and derivatives show fluorescence emission at distinguishable wavelengths.

Analytes

Analytes may be detected either via directly bonded fluorescence markers, or indirectly by competition with added fluorescence marked species, or by concentration-, distance-, pH-, potential- or redox potential-dependent interaction of fluorescence donors and fluorescence/electron acceptors used as markers bonded to one and/or multiple analyte species and/or capture elements. The fluorescence of the donor and/or the fluorescence of the quencher can be measured for the quantification of the analytes.

In the same manner, affinity partners can be labeled in such a way that electron transfer or photoinduced electron transfer leads to quenching of fluorescence upon binding of analyte molecules to capture molecules.

The analytes may be prepared and contacted with the waveguide using a delivery solution. The delivery solution can be an aqueous buffer compatible with the analyte(s). In some embodiments, the delivery solution has a refractive index of about 1.3. In some embodiments, the delivery solution has a refractive index of 1.33 or less.

Detectors

A detector may be arranged to detect fluorescence such as fluorescence.

Affinity partners can be labeled in such a way that Förster fluorescence energy transfer (FRET) can occur upon binding of analyte molecules to capture molecules.

Appropriate detectors for fluorescence include CCD-cameras, CMOS-cameras, photomultiplier tubes, avalanche photodiodes, photodiodes, hybrid photomultiplier tubes. The preferred detector type is CCD- or CMOS-cameras, which allow simultaneous measurement of fluorescence produced by different spots of the chip.

The detector can be arranged to detect changes in refractive index.

The incident beam may be arranged to illuminate the sensing area or all sensing areas on one common platform. Alternatively the beam can be arranged to illuminate only a small sub-area of the sensing area to be analyzed and the beam and/or the platform may be arranged so that they can undergo relative movement in order to scan the sensing area of the platform.

Accordingly the detector may be arranged in an appropriate way to acquire the fluorescence signal intensities of the entire sensing area in a single exposure step. Alternatively the detection and/or excitation means may be arranged in order to scan the sensing areas stepwise.

The apparatus may include a cartridge for location against the sensing area of the platform to bring a sample into contact with the sensing area. The cartridge may contain further means in order to carry out sample preparation, diluting, concentrating, mixing, bio/chemical reactions, separations, in a miniaturized format (see WO 97/02357). The apparatus may include a microtiter type device for containing a plurality of samples to be investigated.

Several figures described below depict the methods and applications of the invention. It is to be understood that the figures are provided so as to illustrate various features and embodiments, and that other embodiments will exist that are not illustrated in the figures. The figures are not to be construed in any manner as to limit the scope of the invention.

An analyte may be detected in a sample by exposing the sample to a light source. A planar waveguide sensor platform can be used and it will be appreciated that the use of such a platform is not necessarily restricted to the particular application to be described.

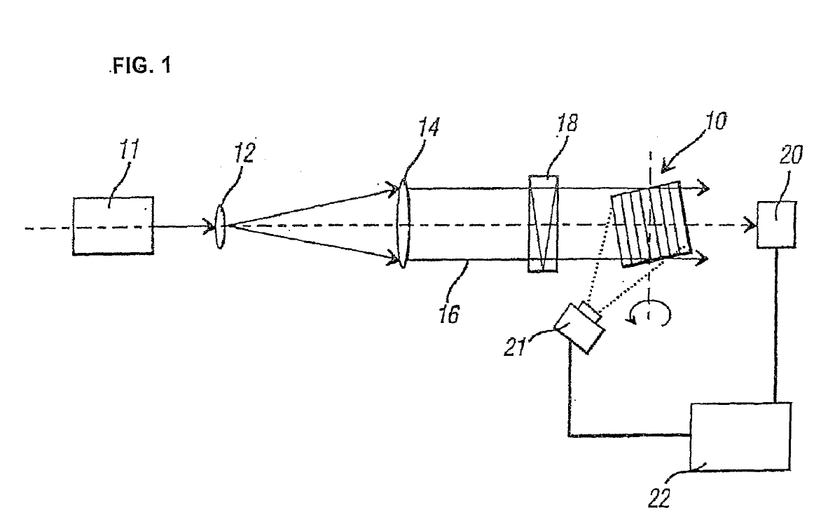

Referring to FIG. 1, a platform (10) in accordance with an aspect of the present invention is shown and can receive coherent light from a laser (11), the laser beam having been shaped by a set of lenses or diffractive element(s) (12, 14) which produce an expanded beam (16). The laser light may be polarized. A plane of polarization may be selected by appropriate positioning of the laser or by means of the optical device rotating plane of polarization (½ wave plate) (18). As will be explained in more detail later, the platform (10) has one or more sensing area(s) to which are attached capture molecules. The wavelength of the light will typically be in the range UV to NIR range, preferably between 350 nm to 1000 nm.

The apparatus also includes a detector (20) that can detect light transmitted through the platform (10), a CCD camera (21) to detect the reflected light and a data processing unit (22).

In use of the apparatus an expanded beam (16) directed toward the grooves of a diffraction grating (not shown), is linearly polarized and caused to be incident on the light-coupling area of the platform (10). A CCD Camera (21) records emissions from molecules hybridized to the surface and excited by an evanescent wave. The length of the expanded excitation beam can exceed the size of the platform (10). The width of this beam is selected for the best performance of the system in terms of efficiency of excitation and system robustness. The angle of incidence of the beam on the platform is adjusted by rotation of the platform (10) until the detector (20) detects effectively no light being transmitted through the platform. The absence of transmitted light indicates the existence of a resonance position at which evanescent waves occur in the sensing area of the platform. Under this condition, the reflected light intensity recorded by the camera (21) reaches a maximum and the data from the camera is acquired by the data processing unit (22) for processing.

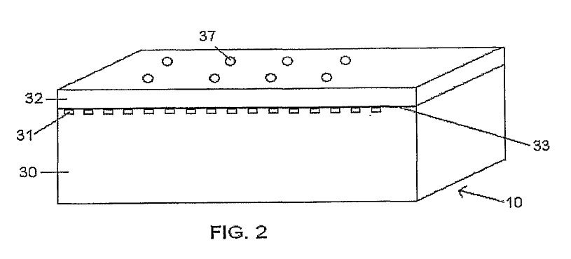

Referring to FIG. 2 of the drawings, the platform (10) comprises a glass substrate (30) into the top surface (33) of which has been etched a diffraction grating (31). A layer of optically transparent metal oxide (32) is deposited on the upper surface (33) of the substrate (30). The substrate (30) can, for example, be formed from glass such as glass AF45 produced by Schott and typically has a thickness of 0.5 mm-1.0 mm. It will be appreciated that other materials can be used for the substrate provided that they are optically transparent.

The optically transparent layer can be a dielectric transparent metal oxide film such as Ta₂O₅ with a high refractive index of approximately 2.2 at a wavelength of 633 nm, i.e. significantly higher than the refractive index of the substrate. The thickness of this layer can be in the range 50 to 200 nm or greater e.g. 50 to 300 nm. The diffraction grating (31) can have a period in the range of 200-1000 nm, e.g. 200 to 500 nm, typically 250-500 nm. The metal oxide can be any of a number of materials such as Ta₂O₅, TiO₂, Nb₂O₅, ZrO₂, or HfO₂.

In a platform such as that shown in FIG. 2, when a beam of polarized laser light is incident thereon at a particular angle of incidence, an effect known as abnormal reflection occurs within the layer (32). When this effect occurs, substantially no light is transmitted through the platform (10) and effectively all the light is reflected within the layer (32) so that the laser light is confined to the very thin layer (32) of waveguide film. The resulting high laser field leaks partially out of the layer (32) creating an evanescent field which evanescently excites fluorescent material which is on the surface or in the close vicinity of the layer (32) and on one or more sensing areas (37).

The intensity of luminescence, e.g. fluorescence, can be increased from samples. The function of the platform can be described in terms of the diffractive structure acting as a volume grating which diffracts light and that the diffractive beams interfere creating a resonance condition where the light reflected from the first interface and light reflected from the top interface that is the upper surface of the layer (32) interfere constructively giving rise to reflection maxima. Under resonance conditions, the laser energy is substantially confined to the thickness of the thin layer (32) thereby increasing the electrical field strength. For a given laser wavelength and period of the corrugated structure, the resonance is angle-dependent. The angle dependent resonance typically has a width at half maximum height (FW) of >0.1°, for example 0.5° or greater or 1.0° or greater.

It will be appreciated that the diffraction grating (31) can be formed on the platform by appropriate conventional techniques. One way of achieving this is to etch grooves by a photographical technique. In this technique, a photoresist composition is deposited on the surface of the substrate to a depth of approximately 1 μm, a periodic structure corresponding to the diffraction grating is then written into the resist either by two beam interferometry/holography or by use of a phase mask, then the resist is etched with a reactive ion etching technique using argon gas, and finally, the residual photoresist material is stripped from the surface. Other ways of incorporating the diffraction include embossing, electron beam writing, laser ablation, and LIGA process.

In some embodiments, a prism (not shown) may be used to couple the light to a waveguide.

Preparation of Platform with Affinity Molecules

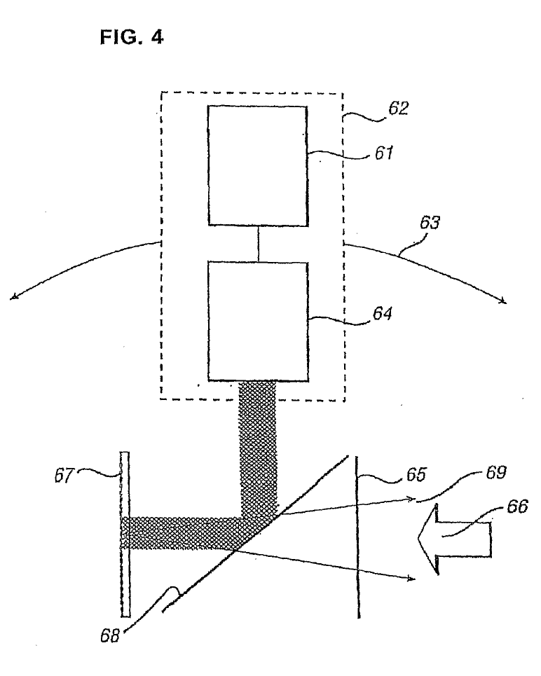

In order to prepare a platform of the type described with reference to FIG. 2 so that it can be used in a measurement such as that illustrated in FIG. 4, a number of procedures can be followed.

The first step is to clean the platform to remove impurities from the platform surface. The cleaning procedure can be carried out by a number of means, for example by means of an ultraviolet cleaner, by plasma cleaning, or by chemical cleaning using materials such as acids, bases, solvents, gases and liquids.

Following platform cleaning, an optional step may be included. This optional step is to apply to the surface of the transparent films a layer of an adhesion promoting agent. This adhesion promoting layer is applied to the platform since capture elements which are to be deposited on the platform might not readily adhere to the metal oxide layer itself. There are several ways in which this adhesion promoting layer can be formed. One way is to form a layer of a network of silane molecules and another way is to use what are known as self-assembled monolayers (SAM). These are known techniques that will be apparent to a person skilled in the art. Silanisation for example which can involve a liquid or gas phase is described in Colloids and Interface Science 6, L Boksanyi, O Liardon, E Kovats, 1976, 95-237. The formation of self-assembled monolayers is described for example in “Ultra thin organic films” by Abraham Ulman, 1991, Academic Press Inc. In addition, there are further methods available for the immobilization of capture elements such as chemical modification of the chip surface with reactive groups and of the capture molecules with appropriate linkers (U. Maskos and E. M. Southern, Nucleic Acids Research 1992, vol. 20, 1679-84), modification of surface and capture molecules with photoreactive linkers/groups (WO 98/27430 and WO 91/16425), immobilization via coulombic interaction (EP 0 472 990 A2), coupling via tags (for instance protein-tag, HIS-tag) in chelating reactions, and various further methods, for instance as described in Methods in Enzymology Academic Press, New York, Klaus Mosbacher (ed.), Vol. 137, Immobilized enzymes and Cells, 1988.

Plasma induced immobilization/generation of adhesion promoting layers may contain functional/reactive groups which enable direct coupling of capture molecules or derivatized capture molecules, or indirect coupling of capture molecules or derivatized capture molecules via chemical linkers or photochemical linkers.

An adhesion promoting layer can for example be produced by silanization with 3-(glycidoxypropyl)trimethoxysilane (GOPTS). Compounds containing nucleophilic groups such as amines can react with an epoxy function of the silane in order to be covalently immobilized. Such a silanization can be used for immobilization of antibodies that contain multiple amino groups since antibodies consist of amino acids. In addition, DNA/RNA/PNA strands as capture molecules can also be modified with amino groups in order to attach these capture molecules covalently at the platform.

In addition, an adhesion promoting layer can be further chemically modified in order to alter the surface properties. For example, a GOPTS-silanized platform can be reacted with functionalized saturated or unsaturated organic/hetero-organic/inorganic molecules/derivatives in order to manipulate hydrophobic/hydrophilic balance of the platform, i.e. change the contact angle of the platform. Furthermore, ionic or potentially ionic compounds can be used to create positive or negative charges at the surface of the platform. Capture molecules can be bound either covalently or by physisorption or by coulombic interaction of charged molecules or by a mixture thereof to such modified surfaces/platforms.

Functionalized organic molecules can be used which provide hydrocarbon chains to render the platform more hydrophobic. Polar groups can be used to render the platform more hydrophilic. Ionic groups or potentially ionic groups can be used to introduce charges. For instance, polyethyleneglycol (PEG) or derivatives thereof can be used to render the platform hydrophilic, which prevents non-specific absorption of proteins to the platform/surface.

Reactive or photoreactive groups may be attached to the surface of the platform that may serve as anchor groups for further reaction steps.

A SAM as an adhesion promoting layer suitable for immobilization of antibodies can be obtained by treatment of the platform with amphiphilic alkylphosphates (e.g. stearyl phosphate). The phosphate headgroup reacts with the hydroxy groups at the surface of the platform and leads to the formation of an ordered monolayer of the amphiphilic alkylphosphates. The hydrophobic alkyl chains render the surface of the platform hydrophobic and thus enable the physisorption of antibodies.

A SAM may also be used for the immobilization of other capture molecules, e.g. for DNA/RNA/PNA strands. In this case, amphiphilic phosphates/phosphates modified e.g. with amine groups or epoxy groups can also be used. The capture molecules can be either coupled directly to the SAM, e.g. to an amine-modified SAM, or after the platform has been reacted with organic derivatives of amines, e.g. aliphatic amines, or branched aliphatic amines, or amines containing aromatic or non-aromatic cyclic structures, or amines containing hetero-atoms, or amines containing functional groups, or amines containing combinations thereof, or any other organic, hetero-organic, and/or inorganic molecules (e.g. epoxy modified SAM).

An adhesion promoting layer may consist of multiple layers in order to manipulate surface characteristics, e.g. hydrophobicity, contact angle, charge density, etc. In addition, a layer attached to the platform with any of the previously mentioned methods may provide chemical functionality which may assist in the formation of the next, subsequent layer or for the coupling of capture molecules. An attachment of chemical, photochemical linker molecules can also be seen as an intermediate layer which enables the attachment of capture molecules to the platform.

This controlled combination of layers/molecules with different functionalities in general is attributed as Supramolecular Chemistry (J-M. Lehn, Supramolecular chemistry—Scope and perspectives. Molecules, supermolecules, and molecular devices, (Nobel Lecture, Aug. 12, 1987), Angew. Chem. Int. Ed. Engl., 27, 89, 1988.). The obtained supramolecular structure can provide a functionality that may be different or apart from the functionality of the individual molecules used for any particular individual layer. An intermediate layer can also introduce luminophores into a layer system, which can either be used as energy donors or energy acceptors/quenchers in the sense of Forster Energy Transfer (FRET) or photoinduced electron transfer, or potential sensitive luminophores before capture molecules or modified capture molecules are attached to the platform.

For the above-described methods of surface treatment, the following organic or inorganic molecules and derivatives thereof can be used: amines, modified amines, jeffamines, aliphatic amines, alcohols, acids, aldehydes, ketones, amides, anhydrides, phosphates, phosphonates, sulfates, sulfonates, thiols, hetero-atom containing compounds, aromatic and aliphatic organic functionalized molecules, aromatic and aliphatic hetero-organic molecules, natural and artificial polymers, silanes, molecules modified with chemical or photochemical active groups, derivatives thereof and functionalized, e.g. omega-functionalized derivatives of the listed species.

In principle, for the build-up of layer structures consisting of one or multiple layers, chemical reactive groups and/or chemical groups having special physical or electro chemical properties (e.g. charges) may be used with the above described surface treatments.

Either chemical/photochemical interactions (e.g. addition, nucleophilic/electrophilic substitution, radical reaction, condensation, reactions with organic/hetero-organic/inorganic carbonyl derivatives, or photo-induced reactions, or thermo-induced reactions, Lewis acid/base concept), and/or physical/electrochemical interaction (e.g. Coulomb-interaction, hydrophobic/hydrophilic interaction), and/or biologic interaction (e.g. antigene/antibody, hybridization, Streptavidin/Avidin-Biotine interaction, agonist/antagonist interaction), and/or photochemical/photophysical interaction may be employed for coupling between molecules/components incorporated into such a layer system/adhesion promoting layer.

Adhesion promotion can also be achieved by deposition of microporous layers or gels on the surface of the platform, the surface characteristics/functionality of the microporous layers or gels facilitating deposition of capture elements shortening the incubation time and enhancing sensitivity of the subsequent measures. The microporous layers can include organic compounds such as polymers, monomers, molecular assemblies, and supra molecular assemblies or it can comprise inorganic compounds such as glass, quartz, ceramic, silicon, and semiconductors.

An adhesion-promoting layer may be produced by silanisation e.g. using 3-(glycidoxypropyl)trimethoxysilane (GOPTS). The adhesion promoting layer may be further chemically modified in order to alter the surface properties. For example, a GOPTS-silanized platform may be reacted with functionalized saturated or unsaturated organic molecules in order to manipulate the hydrophobic/hydrophilic balance of the platform, and thereby altering the contact angle of the platform.

Once the adhesion promoting layer has been formed on the platform a cleaning step or steps may be implemented to remove excess chemicals resulting from preparation of such a layer. After cleaning, the platform can receive capture elements.

A two dimensional array of capture or recognition elements can be formed on the 3-D surface of the adhesion promoting layer previously deposited on the platform. The array of capture elements can be deposited in a variety of ways. Techniques which can be used to deposit capture elements include ink jet printers which have piezoelectric actuators, electromagnetic actuators, pressure/solenoid valve actuators or other force transducers, bubble jet printers which make use of thermoelectric actuators, or laser actuators, ring-pin printers, pin tool-spotters, on-chip-synthesis such as that described in WO90/03382 or WO92/10092, very large scale immobilized polymer synthesis (VLSIPS) such as that described in WO98/27430, photoactivation/photodeprotection of special design photoreactive groups anchored at the surface of the adhesion promoting layer, microcontact printing, microcontact writing pens, drawing pen or pad transfer/stamping of capture elements, microfluidics channels and flowcells made by casting from polymer such as PMMA masters for example using PDMS (polydimethoxysilane) or by micromechanical or mechanical means or made by etching techniques for local delivery of capture elements, structuring of capture elements by photoablation, or deposition of capture elements onto gel pads using one of the previously mentioned techniques or any other photoimmobilisation technique.

The capture or recognition elements that can be deposited onto the platform are many and varied. Generally speaking, the capture molecules used should be capable of affinity reactions. Examples of recognition or capture molecules which can be used with the present platform are as follows: nucleotides, oligonucleotides (and chemical derivatives thereof), DNA (double strand or single strand) (a) linear (and chemical derivatives thereof), (b) circular (e.g. plasmids, cosmids, BACs, ACs) total RNA, messenger RNA, cRNA, mitochondrial RNA, artificial RNA, aptamers PNA (peptide nucleic acids), polyclonal and monoclonal, recombinant, engineered antibodies, antigenes, haptens, antibody FAB subunits (modified if necessary), proteins, modified proteins, enzymes, enzyme cofactors or inhibitors, protein complexes, lectines, histidine labeled proteins, chelators for histidine-tag components (HIS-tag), tagged proteins, artificial antibodies, molecular imprints, plastibodies membrane receptors, whole cells, cell fragments and cellular substructures, synapses, agonists/antagonists, cells, cell organelles, e.g. microsomes, small molecules such as benzodiazapines, prostaglandins, antibiotics, drugs, metabolites, drug metabolites, natural products, carbohydrates and derivatives, natural and artificial ligands, steroids, hormones, peptides, native or artificial polymers, molecular probes, natural and artificial receptors, and chemical derivatives thereof, chelating reagents, crown ether, ligands, supramolecular assemblies, indicators (pH, potential, membrane potential, redox potential), and tissue samples (tissue micro arrays).

The activity or density of the capture molecules can be optimized in a number of ways. The platform with the capture elements deposited thereon can be incubated in saturated water vapor atmosphere for a defined period in order to rehydrate the printed loci. This optimizes the density of the capture molecules, i.e. increases available binding sites per unit area. Subsequently, the incubated chips can be baked for a defined period, such as 1 minute at 80° C. for cDNA capture molecules. The platform can be washed by wetting with a small amount of pure water or any other suitable liquid or solution to avoid cross contamination of the capture elements by excess unbound material. After these procedures, the prepared platform can be stored in a dessicator until use. Prior to use of the chip, an additional washing procedure with 0.1 to 10 ml hybridization buffer or other suitable solution/liquid may be required to reactivate/rehydrate the dried capture elements and to further remove excess unbound capture elements/buffer residues. In the case of DNA capture molecules, the washing procedure has found to be most effective when performed at a temperature between 50° and 85° C.

Process steps for the chip handling can be automated by using hybridization stations such as the GeneTAC Hybridization station from Genomic Solutions Inc., Michigan.

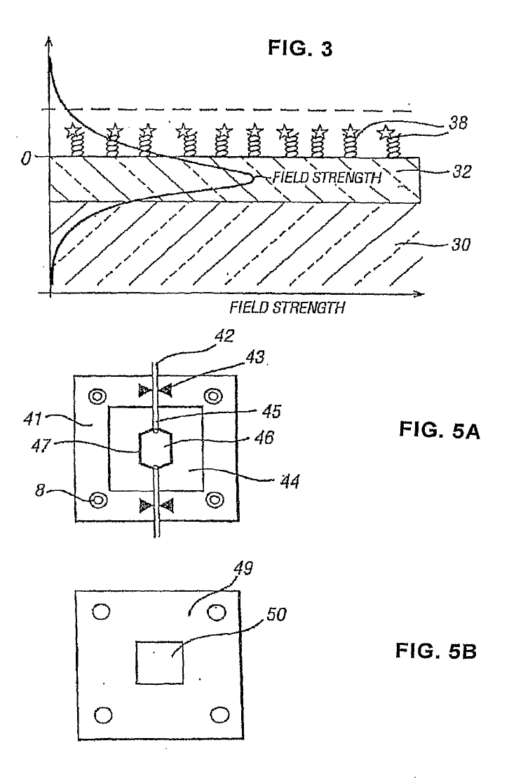

FIG. 3 shows schematically the energy profile of the evanescent field at resonance position and how it extends beyond the surface of the metal oxide layer (32) so that it can excite fluorophores in the close vicinity of the surface of the sensing area, e.g. fluorophores attached to capture molecules or fluorophores attached to molecules bound to the capture molecules (38). The evanescent field intensity decreases exponentially.

It should be appreciated that the specific type of capture molecule or probe used can include a wide range of materials.

Measurement Process

Measurements involving luminescence, in particular fluorescence, can be carried out. A sample suspected of having an analyte is placed on the sensing area of the platform on which the capture elements have been provided. In order to achieve fluorescence, fluorophores can be added to the system prior to observing measurements. The fluorophores can be added to the sample, for example as labeled affinity partners, although it is also possible to attach fluorophores to the capture elements on the platform. The measurements are based upon the fact that fluorescent emission from the capture elements containing labeled capture molecules and/or from labeled affinity partners is altered by its interaction with the analyte or sample under investigation. Labels of different excitation and emission wavelength can be used, there being one or several different labels. For example, label 1 can be for a control experiment, and label 2 can be for the sample.

It will be appreciated that in carrying out an analysis, one or multiple measurements can be made. One measurement can be a background measurement prior to the sample being brought into contact with the capture elements. A second measurement can be made after the sample has been brought in contact with the capture elements. For comparison of multiple samples, for instance “control” and “treated” sample in gene expression experiments, the chip can be regenerated after the “control” experiment and a further background measurement and a measurement after/with the “treated” sample is applied to the chip. To gain information regarding the reaction kinetics of the affinity partners, a complete set of measurements can be recorded as a function of incubation time and/or post-wash time. A typical arrangement for such a measurement is shown in FIG. 4. The platform shown in FIG. 2 is adjusted to the angle at which evanescent resonance is achieved and a measurement of the fluorescence emitted from the surface of the platform is made using a CCD camera (66). This provides an indication of the fluorescence emitted from each position on the array of capture elements deposited on the platform. This can be analyzed to deduce the affinity of the reactions that have occurred between the capture elements and the sample under investigation.

An arrangement as shown in FIG. 4 captures the whole luminescent image of the entire platform with one shot, without the need of any moving parts during measurement. Such a non-scanning device can be very simple and cheap and is especially suited for point-of-care application or portable systems. As shown in FIG. 4, an excitation laser (61) and a 20× beam expander (64) can be jointly mounted onto a goniometer (63). The expanded laser beam can be directed towards the platform (67) by means of a dichroic mirror (68). The center of rotation for the laser beam lay in the plane of the metal oxide layer of the platform (67). The fluorescence emitted from the platform surface can be collected via the dichroic mirror (68). Additional fluorescence filters (65) can be used to separate fluorescence (69) from excitation light. A cooled CCD camera (66) can be equipped with a Nikon Noct lens to measure fluorescence images from the surface platforms. The goniometer allows the adjustment of the angle of the incident expanded laser beam with respect to the surface normal of the platform. Fluorescent images can be taken under evanescent resonance conditions (i.e. the incident expanded laser beam can be adjusted to that angle where the light transmitted through the platform shows a minimum). Another arrangement confines the coherent laser light down to micrometer dimensions by means of optical elements thereby increasing the electrical field in the focal point and the sensing area.

It will be appreciated that a wide variety of samples can be analyzed using the present technique. The sample is generally taken to be the entire solution to be analyzed and this may comprise one or many substances. The sample may be a solution of purified and processed tissue or other materials obtained from biopsy, examination, research and development, or for some diagnostic purpose. The sample may also be a biological medium, such as egg yolk, body fluids or components thereof, such as blood, serum, and urine. It may also be surface water, solution or extracts from natural or synthetic media, such as soils or parts of plants, liquors from biological processes, or synthetic liquors.

In order to carry out the measurement, the sample may be introduced into a sample cell of the type shown in FIGS. 5a and 5b of the drawings. This cell comprises a housing (41) that is made from a polymer such as PMMA. This polymer has been machined to define a central compartment (44) with dimensions corresponding to the dimensions of the platform. A further depression is formed in the compartment (44) to define a chamber (46) that is sealed around its edge by an O-ring (47). The chamber (46) is open at its top and bottom. Solution to be analyzed can be introduced into the chamber (46) within the O-ring (47) through a flow line (45). Flow within the flow line (45) can be controlled by valves (43). The cell includes a cover (49) that can be located over and secured to housing (41) to close the top of the cell. The cover (49) includes a window (50) that locates over the compartment (46) and thereby allows radiation to pass through the cover and into the cell (46).

In use of the cell, the housing (41) can be located against the surface of the platform. The surface can have the capture elements formed thereon so that the lid (49) is remote from that surface. This brings the compartment (46) into communication with the sensing area of the platform. The sample to be investigated is then fed into the compartment (46) through the flow line (45) so that it is brought into contact with the capture elements on the surface of the platform. A measurement of the fluorescence induced at various capture points is then carried out as previously described.

In practice, experiments can have an improvement in observed intensity over a range of refractive indices with an optimal improvement that is relative to the experimental improvements. This optimum may be reflected in plotting intensity with various immersion fluids having different refractive indices. This maximum improvement can shift to lower or higher values depending upon various experimental conditions, such as wavelength(s) of excitation and emission, dye selection, capture molecule selection.

Immersion Fluid

According to another aspect, after an analyte sample is loaded and an affinity reaction allowed to equilibrate, the delivery solution can be removed and replaced with an immersion fluid. Any liquid may be used as the immersion fluid that has a refractive index (n₃) greater than the refractive index of the delivery solution (n_{b}). Generally, the immersion fluid may be stable, have low toxicity, and compatibility with the system and samples, and be transparent or translucent. Additionally, immersion fluids with lower dispersion and high transmittance may be desirable. Transmittance and dispersion are physical properties that can be wavelength dependent. Thus, an immersion fluid may be selected to optimize these properties depending upon the light source and wavelength(s) used for fluorescence excitation and emission. Furthermore, immersion fluids can be selected based on their viscosity, surface tension, and density. Higher viscosity may be indicated for applications where it is undesirable for a solution to run. Lower viscosity may be indicated for application where higher throughput of fluid and experiments are to be run. Lower viscosity fluids may be more desirable to prevent gas bubbles, especially fluorescent quenching gasses. Any of these physical properties may be considered when selecting an immersion fluid so long as they have a refractive index (n₃) greater than the refractive index of the loading solution (or delivery solution) (n_{b}) and less than the refractive index of a surface on waveguide, such as a metal oxide.

The immersion fluid may have a refractive index greater than 1.33. In some embodiments, the immersion fluid has a refractive index less than about 2.2. In some embodiments, the immersion fluid has a refractive index less than about 2.0. In some embodiments, the immersion fluid has a refractive index less than about 1.9. In some embodiments, the immersion fluid has a refractive index less than about 1.8. In some embodiments, the immersion fluid has a refractive index less than about 1.77. In some embodiments, the immersion fluid has a refractive index less than about 1.75. In some embodiments, the immersion fluid has a refractive index less than about 1.73. In some embodiments, the immersion fluid has a refractive index less than about 1.7. In some embodiments, the immersion fluid has a refractive index less than about 1.65.

Immersion fluids can be any fluid that increases or provides a refractive index greater than the delivery solution that contains the analyte of interest. In some embodiments, the delivery solution is a buffer solution with an index of refraction of about 1.3. In other embodiments, the delivery solution is a buffer solution with an index of refraction of about 1.33.

Examples of immersion fluids include refractive index matching liquids available from Cargille Labs, Cedar Grove, N.J. 07009 (www.cargille.com). An appropriate refractive index can be selected greater than 1.33. In some embodiments, a refractive index of between 1.33 and 2.2 may be provided.

A feature of the platform is that the amplitude of an evanescent field at resonance position is greater when fluorescence is measured with the immersion liquid in contact with the sensing area.

In some embodiments, the immersion fluid can be added to the analyte solution while still increasing the relative refractive index. In some embodiments, the immersion fluid is added to the analyte solution before the analyte solution contacts the sensing area. In other embodiments, the immersion fluid is added to the analyte solution after the analyte solution contacts the sensing area. In still other embodiments, the immersion fluid can be added to displace the analyte solution after the analyte solution has contacted the sensing area and the analyte has hybridized or associated with a capture molecule.

In some embodiments, the immersion fluid and the delivery solution are two different fluids. In other embodiments, the analyte can be delivered to the waveguide sensor in the immersion fluid, thus the immersion fluid and the delivery solution may be the same.

Alternate Configurations

The sensing elements can be arranged in various ways, for instance rectangular, circular, hexagonal-centric, ellipsoidal, linear or labyrinthine. The sensing area may be rectangular, round or of any other shape.

The platform can be either rectangular or disc-shaped, or of any other geometry. The platform can comprise one or multiple sensing areas, each sensing area can comprise one or multiple capture elements, and each capture element can comprise one or multiple labeled or unlabelled capture molecules.

The platform can also be adapted to microtiter-type plates/devices in order to perform one or multiple assays in the individual microtiter wells. This can be achieved for all plate types regardless of the number of wells and independently of the dimensions of the respective microtiter-plate.

Reflector

In another aspect, the platform optionally includes a reflector. The reflector is placed in the waveguide layer at the side of the sensor opposite to the diffraction grating or other feature for coupling the laser light into a planar waveguide. The reflector directs excitation light back to the sensing area. In one example, the reflector may be constructed as a Bragg reflector. A typical Bragg filter comprises a length of optical waveguide having periodic perturbations in its index of refraction along its length to reflect light having a wavelength of twice the perturbation spacing. The perturbations can take the form of physical notches in the waveguide, its cladding, or both or can be photoinduced in the guiding material. A Bragg reflector (200) may have distributed variations of the refractive index.

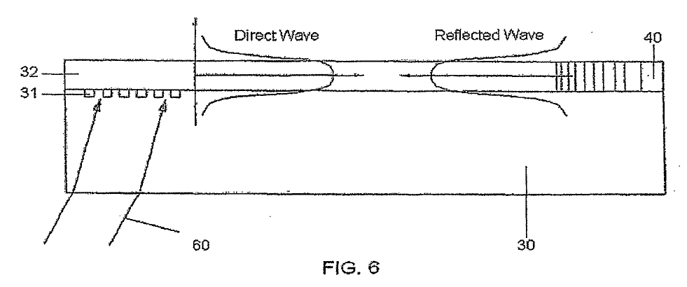

FIG. 6 illustrates a side schematic view of a planar waveguide with a Bragg reflector. An expanded beam of light (16) enters the substrate (30) and the diffraction grating (31). A direct wave is then generated in the optically transparent metal oxide (32) that reflects of the Bragg reflector (40).

In another embodiment, the reflector may be constructed as a retro reflector (202). A retro reflector is designed such that the refractive index of the reflector (nr) is lower than the refractive index of the waveguide film (nf). The angle between the reflective surfaces of the retro reflector is chosen so that it provides total internal reflection for the wave propagating through the waveguide. The retro reflector may be formed for example by a glass—Ta₂O₅ interface. In this case, the retro reflector is formed at the stage of the Ta₂O₅ film deposition with masking of the appropriate area of the planar waveguide surface.

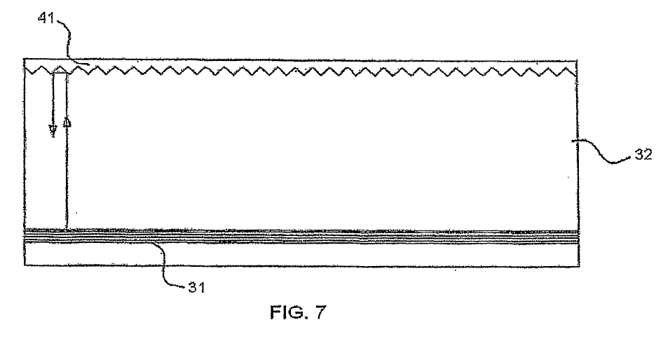

FIG. 7 is a top schematic view of a planar waveguide with a retro reflector. A direct wave generated at the diffraction grating (31) propagates through the transparent metal oxide (32) reflecting off a retro reflector (41).

Focus of Objective Lens

As previously explained, an increase in the depth of penetration of the evanescent wave may also result in a potential increase in signal noise. In order to decrease this potential increase in signal noise, the focus of the objective lens can be decreased. The focus of the objective lens may be achieved by choosing a lens with a lower F-number.

### EXAMPLES

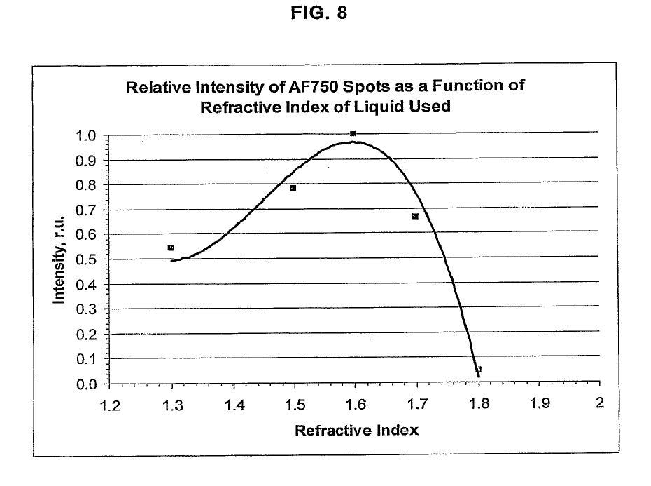

Samples of DNA fragments were labeled with Alexa Fluor 750 dye (AF750, Molecular Probes). The DNA fragments were suspended in a buffer solution with a refractive index of 1.33. The buffer solution was brought in contact with a planar waveguide. The DNA fragments were allowed to hybridize to detection spots on the planar waveguide. Detection spots included capture probes with complimentary chains of DNA fragments. Following hybridization, the buffer solution was replaced with index matching liquids (immersion fluids) from Cargille Labs, Cedar Grove, N.J. 07009 (www.cargille.com) with various indices of refraction. The observed intensity data is displayed in FIG. 8 as a function of refractive index (x axis with intensity on the y axis). The graph reflects that an observed maximum improvement exists arising from the selection of an immersion fluid.

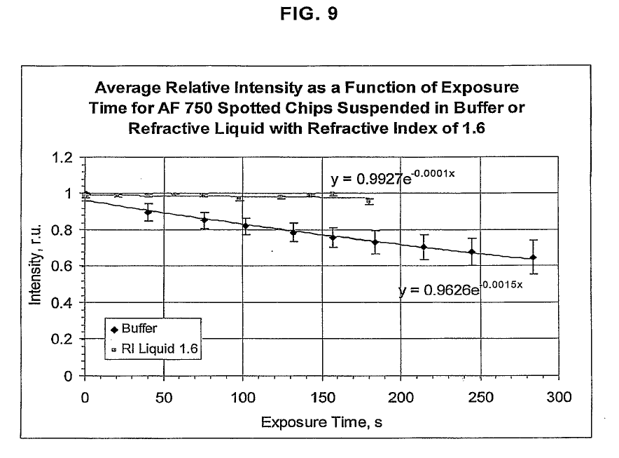

Fluorescence observed from a planar waveguide using a buffer solution with DNA was compared with observations made when the buffer solution is displaced by an immersion fluid with an index of refraction of 1.6 following hybridization. The observations are plotted in FIG. 9 where intensity (y axis) is plotted against the exposure time (x axis) for the two experiments. That data shows that an additional improvement of signal intensity is achieved because the immersion liquid enables a more consistent observed value regardless of the exposure time. While not wishing to be bound to any particular theory, this improvement may be achieved because the immersion liquid reduces the rate of photo bleaching, which may be due a reduction in oxygen concentration relative to the buffer solution.

1. An optical waveguide sensor for detecting the presence or absence of an analyte in a sample, comprising:
an optically transparent substrate having a refractive index n₁;
an optically transparent film bound to a surface of the substrate, wherein the transparent film has a refractive index n₂, and wherein n₂ is greater than n₁;
an analyte specific capture layer bound to the transparent film;
an optical immersion layer overlaying the capture layer, wherein the optical immersion layer has a refractive index n₃, and wherein n₃ is less than n₂ and greater than the refractive index of an aqueous buffer solution.

2. The optical waveguide sensor of claim 1, wherein n₃ is less than n₂ and greater than 1.33.

3. The optical waveguide sensor of claim 1 further comprising a sample, suspected of containing an analyte, in contact with the analyte specific capture layer.

4. The optical waveguide sensor of claim 1, further comprising an analyte, wherein the analyte is bound to the analyte specific capture layer.

5. The optical waveguide sensor of claim 1, further comprising a diffraction grating oriented between the optically transparent substrate and the optically transparent film.

6. The optical waveguide sensor of claim 5, further comprising a reflector oriented opposite the diffraction grating.

7. The optical waveguide sensor of claim 6, wherein the reflector is a retro reflector.

8. The optical waveguide sensor of claim 6, wherein the reflector is a Bragg reflector.

9. The optical waveguide sensor of claim 1, wherein the analyte specific capture layer further comprises one or more capture elements selected from one or more of a nucleotide, an oligonucleotide, DNA, RNA, PNA, an antibody, an antigen, a protein, an antibiotic, a drug, an enzyme, a ligand, a peptide, a polymer, a molecular probe, and a receptor.

10. The optical waveguide sensor of claim 1, further comprising a detectable label capable of indicating the presence or absence of an analyte.

11. The optical waveguide sensor of claim 1, wherein the waveguide sensor further comprises sensing areas arranged in an array.

12. The optical waveguide sensor of claim 1, wherein n₃ is from about 1.35 to about 1.75.

13. (canceled)

14. (canceled)

15. (canceled)

16. (canceled)

17. The optical waveguide sensor of claim 1, wherein n₃ is about 1.6.

18. The optical waveguide sensor of claim 1, wherein n₃ is greater than about 1.35 and less than n₂.

19. (canceled)

20. (canceled)

21. (canceled)

22. (canceled)

23. An optical waveguide device for detecting the presence or absence of an analyte in a sample, comprising:
(a) an optical waveguide sensor, comprising:
an optically transparent substrate having a refractive index n₁,
an optically transparent film bound to a surface of the substrate, wherein the transparent film has a refractive index n₂, and wherein n₂ is greater than n₁,
an analyte specific capture layer bound to the transparent film,
an optical immersion layer overlaying the capture layer, wherein the optical immersion layer has a refractive index n₃, and wherein n₃ less than n₂ and greater than the refractive index of an aqueous buffer solution;
(b) a coupling device for transmitting excitation light in the transparent film;
(c) a light source configured to emit light to the thin film; and
(d) a light detector configured to receive light emitted from the optical waveguide sensor.

24. The optical waveguide device of claim 23, wherein n₃ is less than n₂ and greater than 1.33.

25. The optical waveguide device of claim 23, wherein the optical waveguide sensor further comprises a sample, suspected of containing an analyte, in contact with the analyte specific capture layer.

26. The optical waveguide sensor of claim 23, further comprising an analyte, wherein the analyte is bound to the analyte specific capture layer.

27. The optical waveguide device of claim 23, wherein the optical waveguide sensor further comprises a diffraction grating oriented between the optically transparent substrate and the optically transparent film.

28. The optical waveguide device of claim 27, wherein the optical waveguide sensor further comprises a reflector oriented opposite the diffraction grating.

29. The optical waveguide device of claim 28, wherein the reflector is a retro reflector.

30. The optical waveguide device of claim 28, wherein the reflector is a Bragg reflector.

31. The optical waveguide device of claim 23, wherein the analyte specific capture layer further comprises one or more capture elements selected from one or more of a nucleotide, an oligonucleotide, DNA, RNA, PNA, an antibody, an antigen, a protein, an antibiotic, a drug, an enzyme, a ligand, a peptide, a polymer, a molecular probe, and a receptor.

32. The optical waveguide device of claim 23, further comprising a detectable label capable of indicating the presence or absence of an analyte.

33. The optical waveguide device of claim 23, wherein the waveguide sensor further comprises sensing areas arranged in an array.

34. The optical waveguide device of claim 23, wherein n₃ is from about 1.35 to about 1.75.

35. (canceled)

36. (canceled)

37. (canceled)

38. (canceled)

39. The optical waveguide device of claim 23, wherein n₃ is about 1.6.

40. The optical waveguide device of claim 23, wherein n₃ is greater than about 1.35 and less than n₂.

41. (canceled)

42. (canceled)

43. (canceled)

44. (canceled)

45. A process for using an optical waveguide sensor for detecting the presence or absence of an analyte in a sample, comprising:
(a) providing an optical waveguide sensor comprising:
an optically transparent substrate having a refractive index n₁,
an optically transparent film bound to a surface of the substrate, wherein the transparent film has a refractive index n₂, and wherein n₂ is greater than n₁,
an analyte specific capture layer bound to the transparent film;
(b) contacting the analyte specific capture layer with a sample suspected of containing an analyte;
(c) overlaying the analyte specific capture layer with an optical immersion fluid, wherein the optical immersion fluid has a refractive index n₃ less than n₂ and n₃ greater than the refractive index of an aqueous buffer solution.

46. The process according to claim 45, wherein n₃ is less than n₂ and greater than 1.33.

47. The process according to claim 45, wherein the sample is in a solution, and the optical immersion fluid replaces the buffer solution.

48. The process according to claim 45, wherein the sample is in a solution which solution is mixed with the immersion fluid when the analyte specific capture layer is overlaid with the optical immersion fluid resulting in a mixed fluid with an index of refraction greater than 1.33.

49. The process according to claim 45, wherein the optical waveguide sensor further comprises a diffraction grating oriented between the optically transparent substrate and the optically transparent film.

50. The process according to claim 49, wherein the optical waveguide sensor further comprises a reflector oriented opposite the diffraction grating.

51. The process according to claim 50, wherein the reflector is a retro reflector.

52. The process according to claim 50, wherein the reflector is a Bragg reflector.

53. The process according to claim 45, wherein the analyte specific capture layer further comprises one or more capture elements selected from one or more of a nucleotide, an oligonucleotide, DNA, RNA, PNA, an antibody, an antigen, a protein, an antibiotic, a drug, an enzyme, a ligand, a peptide, a polymer, a molecular probe, and a receptor.

54. The process according to claim 45, further comprises providing a detectable label capable of indicating the presence or absence of an analyte.

55. The process according to claim 45, wherein the waveguide sensor further comprises sensing areas arranged in an array.

56. The process according to claim 45, wherein n₃ is from about 1.35 to about 1.75.

57. (canceled)

58. (canceled)

59. (canceled)

60. (canceled)

61. The process according to claim 45, wherein n₃ is about 1.6.

62. The process according to claim 45, wherein n₃ is greater than about 1.35 and less than n₂.

63. (canceled)

64. (canceled)

65. (canceled)

66. (canceled)

67. A kit for detecting the presence or absence of an analyte in a sample, comprising:
(a) a waveguide sensor comprising:
an optically transparent substrate having a refractive index n₁,
an optically transparent film bound to a surface of the substrate, wherein the transparent film has a refractive index n₂, and wherein n₂ is greater than n₁,
an analyte specific capture layer bound to the transparent film,
(b) an optical immersion fluid, wherein the immersion fluid has a refractive index n₃ and n₃ is less than n₂ and greater than the refractive index of an aqueous buffer solution.

68. The kit according to claim 67, wherein n₃ is less than n₂ and greater than 1.33.

69. The kit according to claim 67, further comprising a buffer solution, wherein the buffer solution has a refractive index of less than or equal to 1.33.

70. The kit according to claim 67, wherein the optical waveguide sensor further comprises a diffraction grating oriented between the optically transparent substrate and the optically transparent film.

71. The kit according to claim 70, wherein the optical waveguide sensor further comprises a reflector oriented opposite the diffraction grating.

72. The kit according to claim 71, wherein the reflector is a retro reflector.

73. The kit according to claim 71, wherein the reflector is a Bragg reflector.

74. The kit according to claim 67, wherein the analyte specific capture layer further comprises one or more capture elements selected from one or more of a nucleotide, an oligonucleotide, DNA, RNA, PNA, an antibody, an antigen, a protein, an antibiotic, a drug, an enzyme, a ligand, a peptide, a polymer, a molecular probe, and a receptor.

75. The kit according to claim 67, further comprising a detectable label reagent capable of indicating the presence or absence of an analyte.

76. The kit according to claim 67, wherein the waveguide sensor further comprises sensing areas arranged in an array.

77. The kit according to claim 67, wherein n₃ is from about 1.35 to about 1.75.

78. (canceled)

79. (canceled)

80. (canceled)

81. (canceled)

82. The kit according to claim 67, wherein n₃ is about 1.6.

83. The kit according to claim 67, wherein n₃ is greater than about 1.35 and less than n₂.

84. (canceled)

85. (canceled)

86. (canceled)

87. (canceled)
